(19) United States
(12) Patent Application Publication
(10) Pub. No.: US 2014/0369028 A1
(43) Pub. Date: Dec. 18, 2014

(54) BACKLIGHT UNIT AND DISPLAY APPARATUS INCLUDING THE SAME

(71) Applicant: INNOLUX CORPORATION, Miaoli County (TW)

(72) Inventors: CHIEN-MING WAN, Miaoli County (TW); WEN-HUNG LEE, Miaoli County (TW); CHE-MING CHANG, Miaoli County (TW); CHENG-TAI CHANG, Miaoli County (TW); CHIN-TU TSAI, Miaoli County (TW)

(73) Assignee: INNOLUX CORPORATION, Miaoli County (TW)

(21) Appl. No.: 14/288,945

(22) Filed: May 28, 2014

(30) Foreign Application Priority Data
Jun. 14, 2013 (TW) 102121132

(51) Int. Cl. F21V 8/00

(52) U.S. Cl. CPC G02B 6/0091; G02B 6/0085
USPC 362/97.1

(57) ABSTRACT

This disclosure provides a backlight unit and a display apparatus including the backlight unit. The display apparatus includes a display panel and a backlight unit which has a light guide plate and a light source module neighboring the light guide plate. The light source module includes: a substrate; a printed-circuit layer having a metal wire and disposed on the substrate; a plurality of light sources having a first height, disposed on the printed-circuit layer, and electrically connected to the metal wire; and at least one protrusion member having a second height and disposed on the metal wire; wherein the second height is larger than the first height and less than or equal to two times the first height.

This application claims the benefit of Taiwan application Serial No. 102121132, filed Jun. 14, 2013, the disclosure of which is incorporated by reference herein in its entirety.

### TECHNICAL FIELD

The present disclosure relates to a backlight unit and a display apparatus including the backlight unit.

### TECHNICAL BACKGROUND

In the flat display technology, a light guide plate is used to transfer a linear light emission into a planar light emission, so as to provide a display panel with a backlight source of uniform brightness. The linear light emission comes from a cold cathode fluorescent lamp (CCFL) or a light bar composed of light-emitting diodes (LEDs) linearly placed on a long-rectangle substrate. Due to the advance of the slim display, the LED light bar may play the leading role in the backlight source.

Conventionally, to assemble a LED light bar onto a backlight unit of a display, the above-mentioned long-rectangle substrate is drilled and screws are used to fix the LED light bar onto a heat sink through the drilled through-holes. However, as the development of flat display products is towards slimness, the width of the LED light bar needs to be decreased further. In such a circumstance, the substrate drilling and screw fixing means is not applicable to mount the LED light bar, because the long-rectangle substrate is subject to structural cracks or defects during the drilling process.

The drilled through-holes may disadvantageously affect wiring layout in the LED light bar and thus downgrade its circuit performance. Also, the screws in the LED light bar may render the heat flow distribution therein converged around the screws, and thus deteriorate the heat dissipation. Consequently, it is in need to develop a new backlight unit for the slim display products.

### TECHNICAL SUMMARY

According to one aspect of the present disclosure, one embodiment provides a display apparatus including a display panel and a backlight unit which has a light guide plate and a light source module neighboring the light guide plate. The light source module includes: a substrate; a printed-circuit layer having a metal wire and disposed on the substrate; a plurality of light sources having a first height, disposed on the printed-circuit layer, and electrically connected to the metal wire; and at least one protrusion member having a second height and disposed on the metal wire; wherein the second height is larger than the first height and less than or equal to two times the first height.

In the embodiment, the substrate has a first width, the at least one protrusion member has a second width, the second width may be larger than or equal to 60 percent of the first width and less than or equal to 80 percent of the first width.

In the embodiment, the substrate and the at least one protrusion member may be of thermal conductivity.

In the embodiment, the light source module may further include an insulation layer between the printed-circuit layer and the plurality of light sources.

In the embodiment, the light sources may be in the form of surface-mount LED.

According to another aspect of the present disclosure, another embodiment provides a backlight unit including a light guide plate and a light source module neighboring the light guide plate. The light source module may include: a substrate; a printed-circuit layer having a metal wire and disposed on the substrate; a plurality of light sources having a first height, disposed on the printed-circuit layer, and electrically connected to the metal wire; and at least one protrusion member having a second height and disposed on the metal wire; wherein the second height is larger than the first height and less than or equal to two times the first height.

In the embodiment, the substrate has a first width, the at least one protrusion member has a second width, the second width may be larger than or equal to 60 percent of the first width and less than or equal to 80 percent of the first width.

In the embodiment, the backlight unit may further include a supporting base of thermal conductivity having a first surface and a second surface vertical to the first surface; wherein the light guide plate is disposed on the first surface and the light source module is bonded to the second surface.

In the embodiment, the backlight unit may further include a supporting base; wherein the light source module may be bonded to the supporting base through a thermal conductive paste.

In the embodiment, the substrate and the at least one protrusion member may be of thermal conductivity, and the at least one protrusion member may have a larger hardness than the light guide plate.

In the embodiment, the light sources may be in the form of surface-mount LED.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 schematically shows a cross-section of a light source module according to one embodiment of the present disclosure.

FIGS. 2A and 2B schematically show top views of a light source module according to one embodiment of the present disclosure.

FIG. 3 schematically shows a cross-section of a backlight unit according to another embodiment of the present disclosure.

FIG. 4 schematically shows a side view of a backlight unit according to another embodiment of the present disclosure.

FIG. 5 schematically shows a display apparatus according to embodiments of this disclosure.

### DESCRIPTION OF THE EXEMPLARY EMBODIMENTS

For further understanding and recognizing the fulfilled functions and structural characteristics of the disclosure, several exemplary embodiments cooperating with detailed description are presented as the following. Reference will now be made in detail to the preferred embodiments, examples of which are illustrated in the accompanying drawings.

In the following description of the embodiments, it is to be understood that when an element such as a layer (film), region, pattern, or structure is stated as being “on” or “under” another element, it can be “directly” on or under another element or can be “indirectly” formed such that an intervening element is also present. Also, the terms such as “on” or “under” should be understood on the basis of the drawings, and they may be used herein to represent the relationship of one element to another element as illustrated in the figures. It will be understood that this expression is intended to encompass different orientations of the elements in addition to the orientation depicted in the figures, namely, to encompass both “on” and “under”. In addition, although the terms “first”, “second” and “third” are used to describe various elements, these elements should not be limited by the term. Also, unless otherwise defined, all terms are intended to have the same meaning as commonly understood by one of ordinary skill in the art.

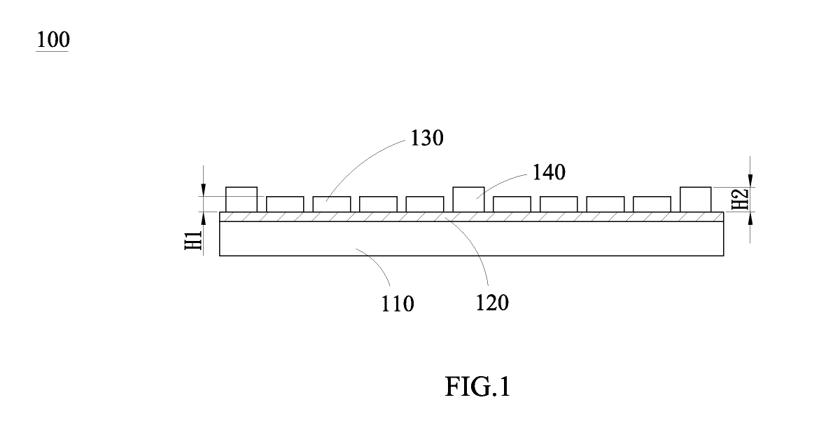

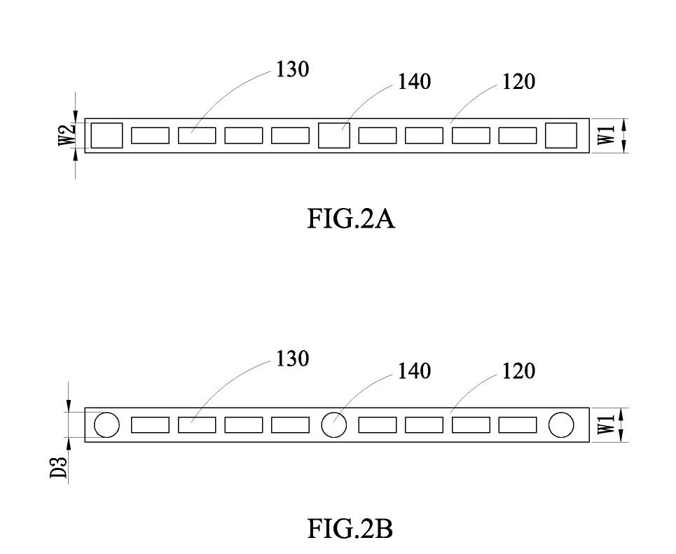

FIG. 1 schematically shows a cross-section of a light source module 100 according to one embodiment of the present disclosure, and its top view can be illustrated in FIG. 2A or 2B. The light source module 100 can be used as a backlight source in a display panel and includes a substrate 110, a printed-circuit layer 120, a plurality of light sources 130 and at least one protrusion member 140. The substrate 110 may be rectangle-shaped or bar-shaped with a long axis, so that the plurality of light sources 130 can be arranged on the substrate 110 along the long axis. The printed-circuit layer 120 is disposed on the substrate 110, so as to provide proper electrical circuit or conductive wiring to drive the plurality of light sources 130. The plurality of light sources 130 is disposed on the printed-circuit layer 120 and electrically connected to the printed-circuit layer 120. The at least one protrusion member 140 is also disposed on the printed-circuit layer 120 along the long axis of the substrate 110, but it is spaced apart from the light sources 130. For example, there are three protrusion members 140 as shown in FIG. 1. In another embodiment, the protrusion members 140 may be disposed only on end portions of the light source module 100; that is, all the protrusion members 140 are located at the right and left end portion of the bar-shaped substrate 110. In another embodiment, all the protrusion members 140 may be disposed only on the center portion of the light source module 100. The locations of the protrusion members 140 are not limited in this disclosure; that is, the protrusion members 140 can be respectively disposed at arbitrary locations on the substrate 110 of the light source module 100, and they are not limited to be aligned in the long axis.

The substrate 110 is configured for supporting the printed-circuit layer 120, the light sources 130 and the protrusion members 140. The light sources 130 may generate a lot of heat during their operation, and the heat may raise the temperature of the light sources 130. Hence, the substrate 110 can be formed of thermal conductive material such as aluminum or the other metal, so as to lower the temperature of the light source module 100 by dissipating the heat outwards through the thermal conductive substrate 110. Besides, because the development of flat display products is towards slimness, the backlight source module in a display panel is designed in a bar shape. Under such a consideration, the substrate 110 may have a long and narrow rectangular shape or a bar shape, and the light sources 130 can be arranged on the substrate 110 in an array along the long axis, becoming a linear backlight source.

As shown in FIG. 2A or 2B, W1 denotes the width of the substrate 110 and, for example, W1 is about 4 mm in the embodiment. The substrate 110 may have a less width for slimmer displays in the future. Conventionally, to fabricate a light source module for slim display produces, the substrate was drilled and screws were used to fix the substrate to a heat sink, so that the heat can be dissipated away from light sources. However, if the width W1 is reduced to about 4 mm or less, the substrate is subject to structural cracks or defects during the drilling process. Wherein, the drilled through-holes may disadvantageously affect wiring or circuit layout of the printed-circuit layer 120 on the substrate, and thus downgrade the circuit performance. The fixing of the screws to the substrate may also render the heat flow distribution in the substrate converged around the screws, and thus deteriorate the heat dissipation.

As shown in FIG. 1, the printed-circuit layer 120 is disposed on the substrate 110, so as to provide proper electrical circuit or conductive wiring to drive the light sources 130. The printed-circuit layer 120 may include a metal wire (not shown) to connect the light sources 130 and their power supply. An insulation layer (not shown) may be interposed between the metal wire and the substrate 110 to prevent them from electrical connection or short-circuiting. Moreover, a protective layer (not shown) of insulating material may be formed on the metal wire to protect the metal wire from external impacts. In another embodiment, the printed-circuit layer 120 may be implemented in a form of printed-circuit board (PCB); wherein, the above-mentioned metal wire may not be in contact with or electrically connected to the substrate 110.

As shown in FIGS. 1, 2A and 2B, the substrate 110 may have a long rectangle shape or a bar shape, and the light sources 130 can be disposed on the substrate 110 and aligned in the direction along the long axis to act as a line light source, which can be used as a one-dimensional backlight source in the display panel. The light sources 130 is disposed on the printed-circuit layer 120 and electrically connected to the printed-circuit layer 120. In the case that the above-mentioned protective layer exists on the metal wire of the printed-circuit layer 120, the light sources 130 are connected to the metal wire via perforations in the protective layer. The light sources 130 may be in the form of surface-mount LED, which can be mounted or soldered directly onto the printed-circuit layer 120 according to the surface-mount technology (SMT). H1 is used to denote the height of the light sources 130. In the embodiment, the surface-mount LEDs have a height H1 of about 0.6 mm, and the distribution of the light sources 130 on the substrate 110 can be defined according to practical requirements for the specification of the backlight source, such as brightness. Considering a substrate 110 with a pre-determined length, the more the light sources 130 are disposed thereon, the more brightness the light source module 100 is able to provide. On the other hand, if the light source module 100 is required for less brightness, a fewer amount of the light sources 130 may be placed on the substrate 110 to reduce the density of the light sources 130. Moreover, the light sources 130 may have a uniform distribution along the long axis on the substrate 110, but it is not limited thereto in this disclosure. The light sources 130 may have a non-uniform distribution, which can be designed according to the emission requirements of the light source module 100.

According to the embodiments in this disclosure, the light source module 100 can be used as a backlight source or a backlight unit in a flat display product. A backlight unit includes a light source module and a light guide plate, and the light emitting surface of the light source module 100 abuts and faces against the light incident surface of the light guide plate, so that the emission of the light source module 100 can go into the light guide plate effectively. In another embodiment, the light emitting surface of the light source module 100 does not directly abut and face against the light incident surface of the light guide plate; instead, the emission of the light source module 100 can be guided by an optical waveguide device to enter the light guide plate. Generally, the light guide plate is made of polymer material such as polymethylmethacrylate (PMMA) and polycarbonate (PC), which tends to change in volume in response to a change in temperature and moisture. The light guide plate abuts the light source module 100, and in the case that the light guide plate expands due to increased temperature or moisture, it may touch and even press the light sources 130 of the light source module 100 to harm the light sources 130 and the backlight unit. Therefore, the protrusion members 140 are disposed on the printed-circuit layer 120 as shown in FIGS. 1, 2A and 2B, acting as a buffer to protect the light sources 130 of the light source module 100 from being touched or pressed by the expanded light guide plate.

The protrusion members 140 may be disposed on the long-rectangle substrate 110 in the direction along its long axis, and they are spaced apart from the light sources 130. The protrusion members 140 may be made of a material having a hardness larger than that of the light guide plate, so that they can act as a buffer or retarder to protect the light sources 130 from being touched or pressed by the expanded light guide plate. Because the protrusion members 140 are not screws, pins or the like, there is no need to drill through-holes in the substrate 110 and the printed-circuit layer 120. Wiring or circuit layout of the printed-circuit layer 120 does not need to avoid possible through-holes and can be arranged under the protrusion members 140, so that the wiring or circuit can be designed in a more preferable and more flexible way.

As shown in FIGS. 1 and 2A, each of the protrusion members 140 is shaped in a rectangular column with width W2 and height H2. To provide a better buffering and protecting effect, the width W2 of the protrusion member 140 may be chosen about 60% to 80% of the width W1 of the substrate 110; that is, (0.8×W1)≧W2≧(0.6×W1). And the height H2 may be chosen larger than the height H1 of the light sources 130 and less than or equal to two times the height H1; that is, (2×H1)≧H2>H1. For example, if the width W1 of the substrate 110 is 4 mm and the height H1 of the light source 130 is 0.6 mm, the width W2 and height H2 of the protrusion members 140 can be set to W2=0.7×W1=2.8 mm and H2=1.5×H1=0.9 mm, respectively. But this disclosure does not limit the dimensions of the substrate 110, the light source 130 and the protrusion members 140.

As shown in FIGS. 1 and 2B, each of the protrusion members 140 is shaped in a circular cylinder with diameter D3 and height H2. To provide a better buffering and protecting effect, the diameter D3 of the protrusion member 140 may be chosen about 60% to 80% of the width W1 of the substrate 110; that is, (0.8×W1)≧D3≧(0.6×W1). And the height H2 may be chosen larger than the height H1 of the light sources 130 and less than or equal to two times the height H1; that is, (2×H1)≧H2>H1. For example, if the width W1 of the substrate 110 is 4 mm and the height H1 of the light source 130 is 0.6 mm, the diameter D3 and height H2 of the protrusion members 140 can be set to D3=0.75×W1=3 mm and H2=2×H1=1.2 mm, respectively.

As shown in FIGS. 2A and 2B, the protrusion members 140 are disposed in the center and end portions of the long-rectangle substrate 110, so as to effectively buffer and protect the light sources 130 from being touched or pressed by the expanded light guide plate. The protrusion members 140 may also be in the form of surface-mount device (SMD), so that they, together with the surface-mount LEDs (the light sources 130), can be mounted or soldered onto the printed-circuit layer 120 according to the surface-mount technology. The amount and location of the protrusion members 140 are not limited in this disclosure, and it depends on the light-emitting requirements of the light source module 100 and the thermal and moisture-caused expansion of the light guide plate.

To further improve the heat dissipating capacity of the light source module 100, the protrusion members 140 can be made of thermal conductive material such as metal and ceramic. For example, the protrusion members 140 can be copper rectangular columns or circular cylinders as shown in FIG. 2A or 2B, so that the heat generated by the light sources 130 can be transferred to the substrate 110 via the protrusion members 140. The shape of the protrusion members 140 is not limited in this disclosure.

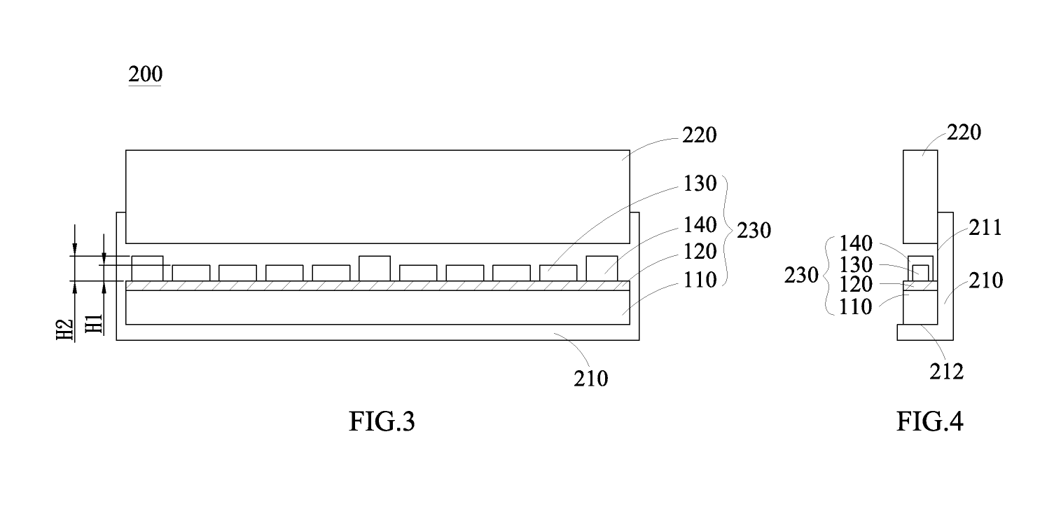

FIG. 3 schematically shows a cross-section of a backlight unit 200 according to another embodiment of the present disclosure, and its side view can be illustrated in FIG. 4. The backlight unit 200 can be used as a backlight source in a display panel and includes a supporting base 210, a light guide plate 220, and a light source module 230. The supporting base 210 is an L-shaped base, configured for supporting the light guide plate 220 and the light source module 230 and for dissipating the heat generated from the light source module 230. The light source module 230, providing linear light emission to work as a backlight source in a display, may be disposed on the supporting base 210. The light guide plate 220 is also disposed on the supporting base 210, configured for transferring a linear light emission into a planar light emission with high brightness and uniformity.

As shown in FIGS. 3 and 4, the supporting base 210 is an L-shaped body with a first surface 211 and a second surface 212 vertical to the first surface 211. The light guide plate 220 is disposed on the first surface 211 and the light source module 230 is disposed on the second surface 212. The supporting base 210, supporting and fixing the light guide plate 220 and the light source module 230, can be the heat sink used in a display panel. Thus, the supporting base 210 can be made of metal material such as aluminum and thereby dissipate the heat from the light source module 230 outwards.

The light guide plate 220 is disposed on the first surface 211 of the supporting base 210, configured for transferring the linear light emission from the light source module 230 into a planar light emission. The light emitting surface of the light source module 230 abuts and faces against the light incident surface of the light guide plate 220, so that the emission of the light source module 230 can enter the light guide plate 220 effectively. The light guide plate 220 may be made of polymer material such as PMMA, which tends to change in volume in response to a change in temperature and moisture. The light guide plate 220 abuts the light source module 230, and in the case that the light guide plate 220 expands due to increased temperature or moisture, it may touch and even press light sources of the light source module 230 to harm the light sources or to cause a downgrade in emitting performance of the backlight unit 200. To solve these problems, protrusion members can be added to the light source module 230.

The light source module 230 is disposed on the second surface 212 of the supporting base 210, configured for providing linear light emission as a backlight source in a display panel. The light source module 230 can be the light source module 100 shown in FIGS. 1 and 2A or 2B, which includes a long-rectangle substrate 110, a printed-circuit layer 120, plural light sources 130 and at least one protrusion member 140. The embodiment has been described in the above context and redundant descriptions would not be recited in the following context. For example, there are three protrusion members 140, as shown in FIG. 3, disposed on the printed-circuit layer 120, acting as a buffer to protect the light sources 130 of the light source module 230 from being touched or pressed by the expanded light guide plate 220.

As shown in FIG. 2A or 2B, the long-rectangle substrate 110 has a width W1; for example, W1 is about 4 mm in the embodiment. As described above, if the width W1 is reduced to about 4 mm or less, the long-rectangle substrate 110 is subject to structural cracks or defects during drilling. Hence the conventional means for fabricating a light source module, in which a long-rectangle substrate is drilled and screws were used to fix the substrate to a heat sink through the drilled through-holes, is not applied to the current embodiment; instead, we use a thermal conductive paste or a thermal-conductive double-side adhesive tape (i.e. twin adhesive tape) (not shown) to bond the long-rectangle substrate 110 to the supporting base 210. Also, the light sources 130 may be surface-mount LEDs, which can be mounted or soldered directly onto the printed-circuit layer 120 according to the surface-mount technology. Wherein, H1 denotes the height of the light sources 130.

In order to buffer and protect the light source module 230 from being touched or pressed by the expanded light guide plate 220, the protrusion members 140 are disposed on the long-rectangle substrate 110 along its long axis. The protrusion members 140 may be made of a material having a hardness larger than that of the light guide plate 220 after thermal or moisture-caused expansion, so that they can act as a buffer or retarder to protect the light sources 130 from being touched or pressed by the expanded light guide plate 220. As shown in FIGS. 3 and 2A, each of the protrusion members 140 is shaped in a rectangular column with width W2 and height H2. To provide a better buffering and protecting effect, the width W2 of the protrusion member 140 may be chosen about 60% to 80% of the width W1 of the substrate 110; that is, (0.8×W1)≧W2≧(0.6×W1). And the height H2 may be chosen larger than the height H1 of the light sources 130 and less than or equal to two times the height H1; that is, (2×H1)≧H2>H1. Alternatively, as shown in FIGS. 3 and 2B, each of the protrusion members 140 is shaped in a circular cylinder with diameter D3 and height H2. To provide a better buffering and protecting effect, the diameter D3 of the protrusion member 140 may be chosen about 60% to 80% of the width W1 of the substrate 110; that is, (0.8×W1)≧D3≧(0.6×W1). And the height H2 may be chosen larger than the height H1 of the light sources 130 and less than or equal to two times the height H1; that is, (2×H1)≧H2>H1.

As shown in FIGS. 2A and 2B, the protrusion members 140 are disposed in the center and end portions of the long-rectangle substrate 110, so as to effectively buffer and protect the light sources 130 from being touched or pressed by the expanded light guide plate 220. To further improve the heat dissipating capacity of the light source module 230, the protrusion members 140 can be made of thermal conductive material such as metal and ceramic. For example, the protrusion members 140 can be rectangular columns or circular cylinders of copper, so that the heat generated by the light sources 130 can be transferred to the long-rectangle substrate 110 via the protrusion members 140. Meanwhile, since the protrusion members 140 are not screws, pins or the like, there is no need to drill through-holes in the long-rectangle substrate 110 and the printed-circuit layer 120. Wiring or circuit layout of the printed-circuit layer 120 does not need to avoid possible through-holes and can be arranged under the protrusion members 140, so that the wiring or circuit can be designed in a more preferable and more flexible way.

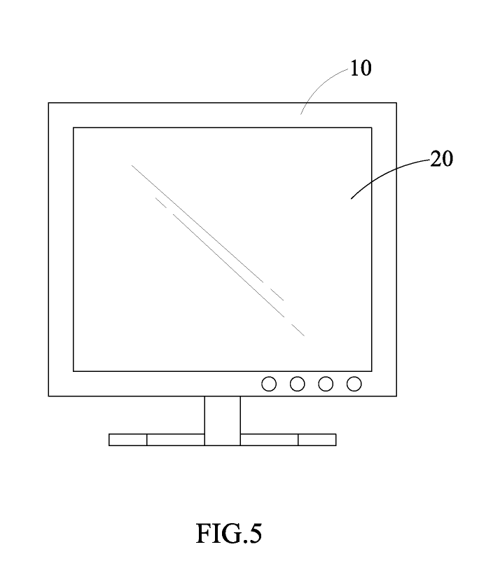

FIG. 5 schematically shows a display apparatus 10 according to embodiments of this disclosure. The display apparatus 10 includes a panel 20 and a backlight unit (not shown) according to the foregoing embodiments. The display apparatus 10 can be a calculator with a monitoring screen, a mobile phone, a tablet computer, or a digital media frame, but this disclosure is not limited thereto. The configuration of the backlight unit can be referred to the above-described embodiments and the panel 20 can be a liquid-crystal (LC) display panel. The LC is composed of crystal-like organic molecules and in a state that has properties between those of conventional liquid and those of solid crystal. The LC molecules may be orientated according to external electrical fields; thereby, the LC display works.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A display apparatus including a display panel and a backlight unit which has a light guide plate and a light source module neighboring the light guide plate, the light source module comprising:
a substrate;
a printed-circuit layer having a metal wire and disposed on the substrate;
a plurality of light sources having a first height, disposed on the printed-circuit layer, and electrically connected to the metal wire; and
at least one protrusion member having a second height and disposed on the metal wire;
wherein the second height is larger than the first height and less than or equal to two times the first height.

2. The display apparatus according to claim 1, wherein the substrate has a first width, the at least one protrusion member has a second width, the second width is larger than or equal to 60 percent of the first width and less than or equal to 80 percent of the first width.

3. The display apparatus according to claim 1, wherein the substrate is of thermal conductivity.

4. The display apparatus according to claim 1, further comprises an insulation layer between the printed-circuit layer and the plurality of light sources.

5. The display apparatus according to claim 1, wherein the at least one protrusion member is of thermal conductivity.

6. A backlight unit including a light guide plate and a light source module neighboring the light guide plate, the light source module comprising:
a substrate;
a printed-circuit layer having a metal wire and disposed on the substrate;
a plurality of light sources having a first height, disposed on the printed-circuit layer, and electrically connected to the metal wire; and
at least one protrusion member having a second height and disposed on the metal wire;
wherein the second height is larger than the first height and less than or equal to two times the first height.

7. The backlight unit according to claim 6, wherein the substrate has a first width, the at least one protrusion member has a second width, the second width is larger than or equal to 60 percent of the first width and less than or equal to 80 percent of the first width.

8. The backlight unit according to claim 6, further comprises a supporting base of thermal conductivity having a first surface and a second surface vertical to the first surface; wherein the light guide plate is disposed on the first surface and the light source module is bonded to the second surface.

9. The backlight unit according to claim 6, further comprises a supporting base;
wherein the light source module is bonded to the supporting base through a thermal conductive paste.

10. The backlight unit according to claim 6, wherein the substrate and the at least one protrusion member are of thermal conductivity, and the at least one protrusion member has a larger hardness than the light guide plate.
